(19) United States
(12) Patent Application Publication
(10) Pub. No.: US 2008/0314880 A1
(43) Pub. Date: Dec. 25, 2008

(54) LASER PROCESSING MACHINE WITH AN OPTICAL DIAPHRAGM

(75) Inventors: Mark Geschwandner, Korntal-Muenchingen (DE); Norbert Haeberle, Gerlingen (DE)

Correspondence Address: FISH & RICHARDSON PC, P.O. BOX 1022, MINNEAPOLIS, MN, 55440-1022, US

(73) Assignee: TRUMPF WERKZEUGMASCHINEN GMBH + CO. KG, Ditzingen (DE)

(21) Appl. No.: 12/041,210

(22) Filed: Mar. 3, 2008

Related U.S. Application Data
(63) Continuation-in-part of application No. PCT/EP2005/009498, filed on Sep. 3, 2005.

(51) Int. Cl. B23K 26/00

(52) U.S. Cl. 219/121.64; 219/121.63

(57) ABSTRACT

A laser processing machine includes focusing optics that intermediately focus the laser beam inside a beam guiding cavity. The laser processing machine also includes an optical diaphragm disposed in the area of the intermediate focus for forming the laser beam, the diaphragm aperture diameter being about 1.2 to about 2.5 times larger than the 99% beam diameter of the intermediately focused laser beam.

### CROSS REFERENCE TO RELATED APPLICATION

This application is a continuation-in-part of, and claims priority under 35 U.S.C. §120 to PCT/EP2005/009498, filed on Sep. 3, 2005, and designating the U.S., which is hereby incorporated by reference in its entirety.

### TECHNICAL FIELD

The invention relates to a laser processing machine, for example, a laser cutting machine or a laser welding machine, including focusing optics that intermediately focus the laser beam inside a beam guiding cavity and including an optical diaphragm disposed in the area of the intermediate focus for forming the laser beam.

### BACKGROUND

A laser processing machine is described, for example, in EP 1 180 409 A1.

In the processing of material using lasers, for example, in laser cutting or welding, the processing result depends on the power density and the beam quality of the laser beam. The laser beam diameter is adjusted at the processing site in order to achieve the desired processing result. In addition to the laser mode, a laser beam also contains diffraction structures (diffraction components) having a larger beam diameter and larger far-field divergence than the laser mode. When the laser beam is focused onto a workpiece to be processed, these diffraction structures lie outside the beam diameter of the laser mode and lead to undesirable heating of the workpiece outside the processing site, which results in reduced cutting or welding quality such as, for example, rough cutting edges, erosion, scaling and small working bandwidths. In addition, in oxygen (O₂) laser cutting, the maximum cuttable material thickness is significantly reduced.

Therefore, optical diaphragms for beam forming, in particular for filtering out diffraction structures are provided on known laser processing machines. EP 1 180 409 A1 describes one way to eliminate diffraction structures (fringing fields) and higher-order laser modes in an intermediately focused laser beam using an optical diaphragm located at the intermediate focus.

### SUMMARY

In one general aspect, a laser processing machine is used to process a workpiece. The laser processing machine includes a laser producing a laser beam having a beam diameter, a beam guiding cavity that receives the laser beam, focusing optics configured to focus the laser beam to an intermediate focus inside the beam guiding cavity, and an optical diaphragm disposed in the area of the intermediate focus and defining an aperture aligned with the laser beam. The optical diaphragm aperture has a diameter that is about 1.2 to about 2.5 times larger than a 99% beam diameter of the intermediately focused laser beam.

Implementations can include one or more of the following features. For example, the laser processing machine can include a coupling-out window at an output of the laser, and a deflecting mirror within the beam guiding cavity. The intermediate focus is located between the coupling-out window and the deflecting mirror.

The optical diaphragm can be located away from the intermediate focus of the laser beam by a maximum of the Rayleigh length. The optical diaphragm can be disposed in the area of the intermediate focus such that the optical diaphragm is less than a Rayleigh length away from the intermediate focus.

The focusing optics can be a non-transmitting optics.

The laser processing machine can include a laser processing head at an end of the beam guiding cavity nearest the workpiece. One or more of the focusing optics and the laser processing head can be non-transmitting optics. The laser processing machine can include a coupling-out window at the output of the laser. One or more of the focusing optics, the coupling-out window, and the laser processing head can be transmitting optics whose thermal lens effect is smaller than that for ZnSe optics.

The laser processing machine can include a coupling-out window at the output of the laser, where the focusing optics is integrated with the coupling-out window.

The focusing optics can be a mirror external to the laser and located in the beam guiding cavity. The focusing optics can be at an output of the laser.

The beam guiding cavity can be flushed with gas. The gas pressures on either side of the optical diaphragm in the gas-flushed beam guiding cavity can be approximately the same.

The laser processing machine can be a laser cutting machine or a laser welding machine. The 99% beam diameter is the beam diameter at which the intensity I of the laser beam is 1% of the intensity I(0) at the center of the laser beam.

In another general aspect, a method for processing a workpiece includes producing a laser beam from a laser, where the laser beam has a beam diameter, directing the laser beam through a beam guiding cavity, focusing the laser beam from the laser to an intermediate focus inside the beam guiding cavity, and directing the laser beam through a central aperture of an optical diaphragm disposed in the area of the intermediate focus. A diameter of the optical diaphragm aperture is about 1.2 to about 2.5 times larger than a 99% beam diameter of the intermediately focused laser beam.

Implementations can include one or more of the following features. For example, the method can include directing the laser beam that exits the beam guiding cavity to the workpiece.

The method can include processing the workpiece with the laser beam. Processing of the workpiece with the laser beam can include welding or cutting the workpiece with the laser beam.

The method can include coupling the laser beam out of the laser through a window at an output of the laser, and deflecting the laser beam within the beam guiding cavity with a mirror. The intermediate focus is located between the coupling-out window and the deflecting mirror.

The optical diaphragm can be located away from the intermediate focus of the laser beam by a maximum of the Rayleigh length. The optical diaphragm can be disposed in the area of the intermediate focus such that the optical diaphragm is less than a Rayleigh length away from the intermediate focus.

The laser beam at the output of the laser can be focused by directing the laser beam through non-transmitting optics.

The method can include directing the laser beam out of the beam guiding cavity at an end of the cavity nearest the workpiece and through a laser processing head.

The laser beam at the output of the laser can be focused by directing the laser beam through a mirror external to the laser and located within the beam guiding cavity.

The method can include flushing the beam guiding cavity with gas. The method can include maintaining gas pressures on either side of the optical diaphragm in the gas-flushed beam guiding cavity approximately equal.

In another general aspect, a laser processing machine includes focusing optics that intermediately focus a laser beam inside a beam guiding cavity, and an optical diaphragm disposed in the area of the intermediate focus for forming the laser beam. The optical diaphragm aperture diameter is about 1.2 to about 2.5 times larger than the 99% beam diameter of the intermediately focused laser beam (that is, of the laser beam at the intermediate focus ZF). The 99% beam diameter D_{99%} is defined as the beam diameter at which the intensity I of the laser beam is 1% of the intensity I(0) at the center of the laser beam, where the I(0) at the center of the laser beam is the maximum intensity.

Experiments on an oxygen (O₂) laser cutting machine have resulted in significantly smoother cutting edges without scaling. This improved cutting quality is attributed to the fact that diffraction structures present in the laser beam which, at the processing site, lead to heating of the workpiece outside the processing site, are eliminated.

The choice of the focal length of the focusing optic is limited “upwards” by the maximum geometrical dimensions of the laser processing machine and “downwards” by the thermal or mechanical stability in the kW laser range and the adjustability of the optical diaphragm. Diaphragm diameters less than 1 mm are not practical in the multi-kW range. The intermediate focus is located between a coupling-out window of a laser resonator of the laser and a deflecting mirror within the beam guiding cavity, for example, if there are several deflecting mirrors within the beam guiding cavity, the first deflecting mirror.

The optical diaphragm does not need to be located exactly at the intermediate focus, i.e., in the beam waist of the intermediately focused laser beam, but can be located remote from the intermediate focus at a maximum of the Rayleigh length. In this region around the beam waist (that is, within a distance of the Rayleigh length), the Fresnel number is equal to or approximately zero and therefore the spatial separation between laser mode and diffraction structures is greatest so that diffraction structures can be filtered out here and the losses in the laser mode are lower or lowest.

Elements that cause no focal shift are preferably inserted in the beam path. For this reason, the focusing optics and a laser processing head of the laser processing machine are non-transmitting optics or transmitting optics whose thermal lens effect is smaller than that for ZnSe optics. Transmitting optics (e.g., ZnSe lenses) change their refractive index as a function of the transmitted laser power by absorption of the laser radiation and the formation of a temperature gradient so that a so-called thermal lens is formed. This lens effect results in migration of the focal point along the direction of propagation in the area of the intermediate focus and in a perturbing power-dependent focal shift at the processing site (that is, at the laser processing head such as a cutting head, welding head, etc.). Transmitting optics having a small lens effect (e.g., diamond coupling-out windows) or non-transmitting optics (e.g., processing head with mirror optics) should be selected for optimal functionality of the optical diaphragm and a small focal shift at the processing site. ZnSe lenses at these positions are certainly possible but have the aforesaid disadvantages.

The focusing optics can be, for example, an external mirror arranged in a beam guiding cavity or a delta convolution or, can be integrated in the coupling-out window.

The beam guiding cavity is preferably flushed with gas, where the gas pressures prevailing before and after the optical diaphragm are advantageously the same or almost the same.

Various embodiments of this laser processing machine can eliminate or substantially reduce perturbing diffraction structures (fringing fields) without significant intensity losses occurring in the laser mode. In particular, because the diaphragm aperture is selected to be about 1.2 to about 2.5 times larger than the 99% beam diameter of the intermediately focused laser beam, in the gas-cleaned beam guiding cavity, overpressure (that is, a significantly higher pressure) is reduced before the optical diaphragm relative to after the optical diaphragm. Thus, the diaphragm aperture does not act as a throttle point for the flushing gas flowing through the beam guiding cavity and does not reduce the amount of gas flowing through the beam guiding cavity. Moreover, the size of the diaphragm aperture is selected to reduce intensity losses of the laser mode.

Further advantages of the invention are obtained from the description and the drawings. Likewise, the features specified hereinbefore and listed further on can be used by themselves or as a plurality in any combinations. The embodiment which is shown and described is not to be understood as a conclusive listing but rather has an exemplary character for describing the invention.

### DESCRIPTION OF THE DRAWINGS

FIG. 1 is a schematic diagram of a laser processing machine showing the beam path of the laser beam; and

FIG. 2 shows a graph of an intensity profile of the laser beam shown in FIG. 1 at an intermediate focus plotted as a function of the beam radius R.

### DETAILED DESCRIPTION

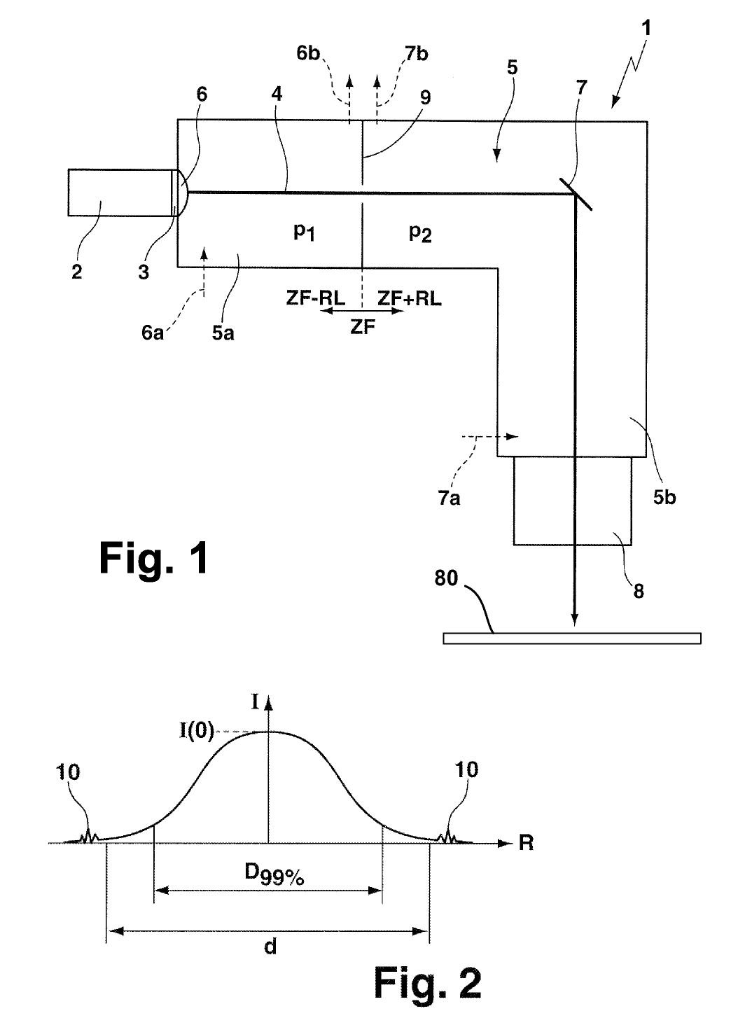

Referring to FIG. 1, a CO₂ laser processing machine 1 includes a CO₂ laser generator 2 with a coupling-out window (such as a coupling-out mirror) 3 through which a laser beam 4 is coupled out into a gas-flushed beam guiding cavity 5. The beam guiding cavity 5 can be any hermetically-sealed enclosure that, for example, provides a cavity for flushing gas, that prevents stray light from exiting the laser processing machine 1.

The laser processing machine 1 includes focusing optics 6 that intermediately focus the laser beam 4 in the beam guiding cavity 5 to an intermediate focus ZF. The position of the intermediate focus ZF is arbitrary but it is appropriate to select a fixed distance between two optical elements, in this example, between the coupling-out window 3 and a deflecting mirror 7. The focusing optics 6 can be, for example, an external mirror arranged in the beam guiding cavity 5 or a delta convolution. Or, the focusing optics 6 can be integrated in the coupling-out window 3 (as shown in FIG. 1) for example, by fabricating the window 3 to also be a focusing optics or by attaching a separate focusing optics 6 to the window 3.

The laser beam 4 is deflected at the deflecting mirror 7 and optionally at other elements, and then is focused with a laser processing head 8 onto a workpiece to be processed 80. The laser processing machine 1 can be, for example, a laser cutting machine or laser welding machine.

Referring also to FIG. 2, the laser processing machine 1 also includes a water-cooled optical diaphragm (also known as a spatial diaphragm) 9 having a circular diaphragm aperture. The optical diaphragm 9 is located at the intermediate focus ZF for forming the laser beam 4. As the intensity I plotted as a function of the beam radius R in FIG. 2 shows, the diaphragm aperture diameter d is significantly greater than a 99% beam diameter (D_{99%}) of the laser beam 4 at the intermediate focus ZF. The 99% beam diameter D_{99%} is defined as the beam diameter at which the intensity I of the laser beam 4 is 1% of the intensity I(0) at the center of the laser beam 4, where the intensity I(0) at the center (where R=0) of the laser beam 4 is the maximum intensity. The ratio d/D_{99%} should lie between about 1.2 and about 2.5 and in the exemplary embodiment shown is about 1.4. For a circularly symmetrical 99% beam diameter D_{99%} of about, for example, 6 mm, the diaphragm aperture diameter d is selected to be between about 7.2 mm and 15.0 mm. The diaphragm aperture diameter d should be small enough to block diffraction structures 10 present in the laser beam 4. Such diffraction structures 10 can lead to heating of the workpiece outside of the processing site.

The optical diaphragm 9 does not need to be located exactly at the intermediate focus ZF, i.e., in the beam waist of the intermediately focused laser beam 4 but can be located remote from the intermediate focus ZF by a maximum of the Rayleigh length RL. In one implementation, for easier maintenance and easier adjustment of the position of the optical diaphragm 9, the intermediate focus ZF and therefore the optical diaphragm 9 is about 1 m to 2 m from the focusing optics 6. In the region around the beam waist but within the Rayleigh length RL, the Fresnel number is equal to or approximately zero and therefore the spatial separation between laser mode and diffraction structures is greatest so that diffraction structures can be filtered out here and the losses in the laser mode are lower or lowest.

The choice of the focal length of the focusing optics 6 is limited “upwards” by the maximum geometrical dimensions of the laser processing machine 1 and “downwards” by the thermal or mechanical stability in the kW laser range and the adjustability of the optical diaphragm 9. Diaphragm diameters less than about 1 mm are not practical for a laser generator 2 operating in the multi-kW range.

Experiments on a laser cutting machine configured in this manner using oxygen (O₂) as cutting gas have resulted in significantly smoother cutting edges without scaling (that is, without oxidation of the workpiece at a temperature above 500° C., for example, to produce iron oxide). This improved cutting quality is attributed to the fact that the diffraction structures 10 present in the laser beam 4 are eliminated or greatly reduced by the optical diaphragm 9.

Elements that cause no focal shift are preferably inserted in the beam path of the laser beam 4. For this reason, in some implementations, the focusing optics 6 and the laser processing head 8 are non-transmitting optics or transmitting optics whose thermal lens effect is smaller than that for ZnSe optics. Transmitting optics (e.g., ZnSe lenses) change their refractive index as a function of the transmitted laser power by absorption of the laser radiation and the formation of a temperature gradient so that a so-called thermal lens is formed. This lens effect results in migration of the focal point along the direction of propagation in the area of the intermediate focus and in a perturbing power-dependent focal shift at the processing site (that is, at the cutting head, the welding head, etc.). Transmitting optics having a small lens effect (e.g., diamond coupling-out windows 3) or non-transmitting optics (e.g., a processing head with mirror optics) are selected for optimal functionality of the optical diaphragm and a small focal shift at the processing site. Moreover, ZnSe lenses at these positions can be possible.

Accordingly, in some implementations, the coupling-out window 3 and the integrated focusing optics 6 are made of diamond and the laser processing head 8 is a mirror cutting head. In this way, functionality of the optical diaphragm 9 is improved and the focal shift at the processing site is reduced.

The beam guiding cavity 5 is divided into two partial cavities 5a, 5b by the optical diaphragm 9 and is flushed with a flushing gas (such as an inert gas, for example Argon) to prevent or reduce the penetration of particles or gases into the beam guiding cavity 5 from outside of the cavity 5. The flushing gas is fed into the anterior partial cavity 5a near the coupling-out window 3 (flow arrow 6a) and is guided out again before the optical diaphragm 9 by using an excess pressure valve (not shown) (flow arrow 6b). Similarly, the flushing gas is fed into the posterior partial cavity 5b near the laser processing head 8 (flow arrow 7a) and is guided out again after the optical diaphragm 9 using an excess pressure valve (not shown) (flow arrow 7b). The two excess pressure valves can be set to the same opening pressure so that gas pressures p₁, p₂ prevailing in the gas-flushed beam guiding cavity 5 before and after, respectively, the optical diaphragm 9 are the same or approximately the same and the optical diaphragm 9 has no or little throttle effect for the flushing gas present in the beam guiding cavity 5. In addition, the optical diaphragm 9 can have additional through apertures by which pressure can be equalized between the two partial cavities 5a, 5b. These additional through apertures are off-center and have little to no impact on the laser beam 5 so that these additional through apertures serve to facilitate pressure equalization.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A laser processing machine for processing a workpiece the laser processing machine comprising:
a laser producing a laser beam having a beam diameter;
a beam guiding cavity that receives the laser beam from the laser;
focusing optics configured to focus the laser beam to an intermediate focus inside the beam guiding cavity; and
an optical diaphragm disposed in the area of the intermediate focus and defining an aperture aligned with the laser beam;
wherein the optical diaphragm aperture has a diameter about 1.2 to about 2.5 times larger than a 99% beam diameter of the intermediately focused laser beam.

2. The laser processing machine of claim 1, further comprising:
a coupling-out window at an output of the laser; and
a deflecting mirror within the beam guiding cavity;
wherein the intermediate focus is located between the coupling-out window and the deflecting mirror.

3. The laser processing machine of claim 1, wherein the optical diaphragm is located away from the intermediate focus of the laser beam by a maximum of the Rayleigh length.

4. The laser processing machine of claim 1, wherein the optical diaphragm is disposed in the area of the intermediate focus such that the optical diaphragm is less than a Rayleigh length away from the intermediate focus.

5. The laser processing machine of claim 1, wherein the focusing optics is a non-transmitting optics.

6. The laser processing machine of claim 1, further comprising a laser processing head at an end of the beam guiding cavity nearest the workpiece.

7. The laser processing machine of claim 6, wherein one or more of the focusing optics and the laser processing head is non-transmitting optics.

8. The laser processing machine of claim 6, further comprising:
a coupling-out window at the output of the laser;
wherein one or more of the focusing optics, the coupling-out window, and the laser processing head are transmitting optics whose thermal lens effect is smaller than that for ZnSe optics.

9. The laser processing machine of claim 1, further comprising a coupling-out window at the output of the laser, wherein the focusing optics is integrated with the coupling-out window.

10. The laser processing machine of claim 1, wherein the focusing optics is a mirror external to the laser and located in the beam guiding cavity.

11. The laser processing machine of claim 1, wherein the beam guiding cavity is flushed with gas.

12. The laser processing machine of claim 11, wherein gas pressures on either side of the optical diaphragm in the gas-flushed beam guiding cavity are approximately the same.

13. The laser processing machine of claim 1, wherein the laser processing machine is a laser cutting machine.

14. The laser processing machine of claim 1, wherein the laser processing machine is a laser welding machine.

15. The laser processing machine of claim 1, wherein the 99% beam diameter is the beam diameter at which the intensity I of the laser beam is 1% of the intensity I(0) at the center of the laser beam.

16. The laser processing machine of claim 1, wherein the focusing optics is at an output of the laser.

17. A method for processing a workpiece, the method comprising:
producing a laser beam from a laser, where the laser beam has a beam diameter;
directing the laser beam through a beam guiding cavity;
focusing the laser beam at an output of the laser to an intermediate focus inside the beam guiding cavity;
directing the laser beam through a central aperture of an optical diaphragm disposed in the area of the intermediate focus;
wherein a diameter of the optical diaphragm aperture is about 1.2 to about 2.5 times larger than a 99% beam diameter of the intermediately focused laser beam.

18. The method of claim 17, further comprising directing the laser beam that exits the beam guiding cavity to the workpiece.

19. The method of claim 17, further comprising processing the workpiece with the laser beam that exits the beam guiding cavity.

20. A laser processing machine comprising:
focusing optics that intermediately focus the laser beam inside a beam guiding cavity; and
an optical diaphragm disposed in the area of the intermediate focus for forming the laser beam;
wherein the diaphragm aperture diameter is about 1.2 to about 2.5 times larger than the 99% beam diameter of the intermediately focused laser beam.
